(19) United States
(12) Patent Application Publication
(10) Pub. No.: US 2011/0008612 A1
(43) Pub. Date: Jan. 13, 2011

(54) SELF-CLEANING SURFACES

(75) Inventor: Kwangyeol Lee, Namyangju-si (KR)

Correspondence Address: Workman Nydegger;1000 Eagle Gate Tower, 60 East South Temple, Salt Lake City, UT, 84111, US

(73) Assignee: Korea University Research and Business Foundation, Seoul (KR)

(21) Appl. No.: 12/500,917

(22) Filed: Jul. 10, 2009

(51) Int. Cl. B32B 5/16; B05D 3/02

(52) U.S. Cl. 428/325; 427/190; 428/323; 977/701; 977/890; 977/904

(57) ABSTRACT

A self-cleaning surface and methods of forming a self-cleaning surface that has one or more of hydrophobic characteristics and hydrophilic properties are provided. The self-cleaning surface includes a first layer formed from first nanoparticles that are applied on a substrate. A second layer of second nanoparticles that adhere to the first nanoparticles are then formed on the first layer.

### TECHNICAL FIELD

Embodiments described herein relate to self-cleaning surfaces. More particularly, embodiments relate to self-cleaning surfaces that are repellent to water and other contaminants and/or are photocatalytic.

### BACKGROUND

The lotus leaf, often referred to as the water lily, is well known for its ability to stay dry and clean. When water drops on a lotus leaf, the water rolls off the surface of the leaf. As the water rolls off of the leaf's surface, it can “wash” the surface of the leaf at the same time. As a result, the lotus leaf has the advantage of being repellant to both water and contaminants.

Although the lotus leaf may appear waxy to the unaided eye, its surface has micro-bumps that provide the lotus leaf with the ability to repel water and contaminants. These characteristics allow the lotus leaf to repel both water and contaminants. The ability to form or manufacture surfaces that have similar properties, however, has proven elusive.

### BRIEF DESCRIPTION OF THE FIGURES

FIG. 1 illustrates a substrate that may be used to form a self-cleaning surface;

FIG. 2A illustrates an example of a nanoparticle coated with a volume changing material in an expanded state;

FIG. 2B illustrates the nanoparticle illustrated in FIG. 2A after the onset of water loss from the volume changing material;

FIG. 3 illustrates an example of coated nanoparticles that have been applied to a substrate;

FIG. 4A illustrates a top view of coated nanoparticles that have been applied to a substrate;

FIG. 4B illustrates the top view of the surface after the shells of the coated nanoparticles have been reduced in volume or removed and illustrates that the shells can provide spacing between the nanoparticles on the substrate;

FIG. 5 illustrates that the nanoparticles can be arranged in different patterns or in an asymmetrical manner on the substrate;

FIG. 6 illustrates one embodiment of a self-cleaning surface where additional nanoparticles have been applied to the self-cleaning surface; and

FIG. 7 is a flow diagram of an illustrative embodiment of a method for forming a self-cleaning surface.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Embodiments described herein relate to surfaces and to methods for forming or making surfaces that are configured to provide various properties or to have certain characteristics. By way of example only, the surfaces may be hydrophobic and/or hydrophilic. As a result, embodiments relate to surfaces that may be repellent to water, repellent to contaminants, antifouling, and the like or any combination thereof. In general, these surfaces are referred to herein as self-cleaning surfaces. As such, a self-cleaning surface can be a surface that has these characteristics or properties.

Embodiments described herein further relate to hydrophobic or superhydrophobic surfaces. In these embodiments, water may have an angle of contact with the surface that is greater than 90 degrees, greater than 150 degrees, greater than 160 degrees, between 90 and 170-180 degrees, between about 90 degrees and about 175 degrees, and the like. The angle of contact can be sufficient to provide hydrophobicity or superhydrophobicity. At the same time in certain embodiments, the surfaces may be hydrophilic or at least partially hydrophilic.

The hydrophobic aspect of embodiments of the surface can be used to make the surface self-cleaning, which in one example, provides a surface that is repellant to water and/or contaminants. The hydrophilic aspect of embodiments of the surface can be self-cleaning as well. The hydrophilic aspect of the surface may decompose contaminants such as dirt using reactive radicals (e.g., OH radical), which may be generated from the photocatalytic conversion from water mediated by appropriate nanoparticles included in the surface.

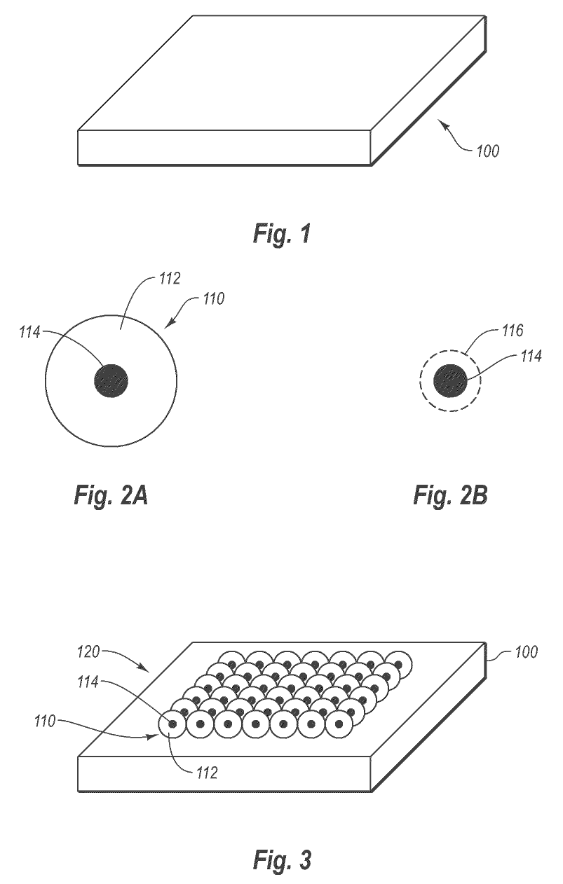

FIG. 1 illustrates an example of a substrate 100 on which a surface may be formed. The substrate 100 may be formed from glass or other material such as metal, ceramics, and the like. The substrate 100 can be flat or may have a different shape including curved, angled, and the like. Because the resulting surface may be hydrophilic and/or hydrophobic, and/or repellant to other contaminants, the surface may be used in construction, manufacturing (e.g., automobiles), and other applications or applied to the materials used in these applications. The shape of the substrate 100 can also be adapted to these applications. In some instances, the substrate 100 may be rigid, but the substrate 100 may also be flexible in some embodiments. In addition, the substrate 100 can be of any shape prior to forming the a self-cleaning surface thereon.

FIG. 2A illustrates an example of a nanoparticle 114 coated with a volume changing material in an expanded state. The nanoparticle 114 may be used to form a surface on a substrate, such as the substrate 100. The nanoparticle 114 may be formed from various materials, including silicon or other semiconductor material or an oxidized material such as silicon dioxide SiO₂. In FIG. 2A, the nanoparticle 114 has been coated or encased in a shell 112 to form a coated nanoparticle 110.

The shell 112 may be formed from a polymer shell, for example a hydrogel. The hydrogel can be any material that can absorb water and greatly change in volume due to the absorption of the water. In one embodiment, the hydrogel can absorb water to increase in size by at least about 50 vol %, alternatively at least about 75 vol % or even at least about 100 vol % or more. The increase in volume may be more or less and can be determined, in some examples, prior to forming the surface. As described in more detail below, the increase in volume may be determined according to a desired spacing between the nanoparticles 114 when applied to a substrate, such as the substrate 100.

The hydrogel is typically a water-insoluble polymeric material that can form a colloidal gel in which water is the dispersion medium. Examples of materials that can be included in the hydrogels include, but are not limited to, polyvinyl alcohol and acrylates such as sodium polyacrylate. In one embodiment, the hydrogel can be thermally sensitive. Thermally sensitive hydrogels have a water absorption capacity that is dependent on temperature (i.e., the onset of water loss is substantially non-linear in a particular temperature range). An example of a suitable thermally sensitive hydrogel includes, but is not limited to poly(N-isopropylacrylamide). In one embodiment, the thermally sensitive hydrogel has an onset of water loss that is in a range from about 15° C. to about 30° C., or alternatively in a range from about 20° C. to about 25° C.

FIG. 2B illustrates the nanoparticle 114 after the onset of water loss from the volume changing material. In FIG. 2B, a change in volume of the coated nanoparticle 110 occurs as the water is released from the shell 112 and the coated nanoparticle 110 changes from an expanded state to a reduced state. As the volume of the hydrogel or other volume changing material reduces, the hydrogel shell 112 can be significantly reduced or even completely removed from the nanoparticle 114. Thus, the nanoparticles 114 illustrated in FIG. 2A may be coated with hydrogel to form the coated nanoparticle 110 at a temperature that is lower than the temperature or temperature range at which water loss from the shell 112 occurs. As described below, as the temperature increases, water loss occurs, leaving the nanoparticles 114 on the substrate 100. The nanoparticles 114 may be spaced on the substrate 100 according to the dimensions of the shell 112.

FIG. 3 illustrates an example of the coated nanoparticles 110 that have been applied to a substrate, such as the substrate 100. FIG. 3 also provides a perspective view of the coated nanoparticles 110 that have been deposited on the substrate 100. The coated nanoparticles 110 can be deposited or applied by spraying or by immersion of the substrate 100 in a solution or mixture, for example. Spraying or otherwise placing the coated nanoparticles 110 on the substrate 100 begins the process of forming a self-cleaning surface 120 that may be water repellent, contaminant repellant, photocatalytic, hydrophobic, hydrophilic, antifouling, and the like or any combination thereof.

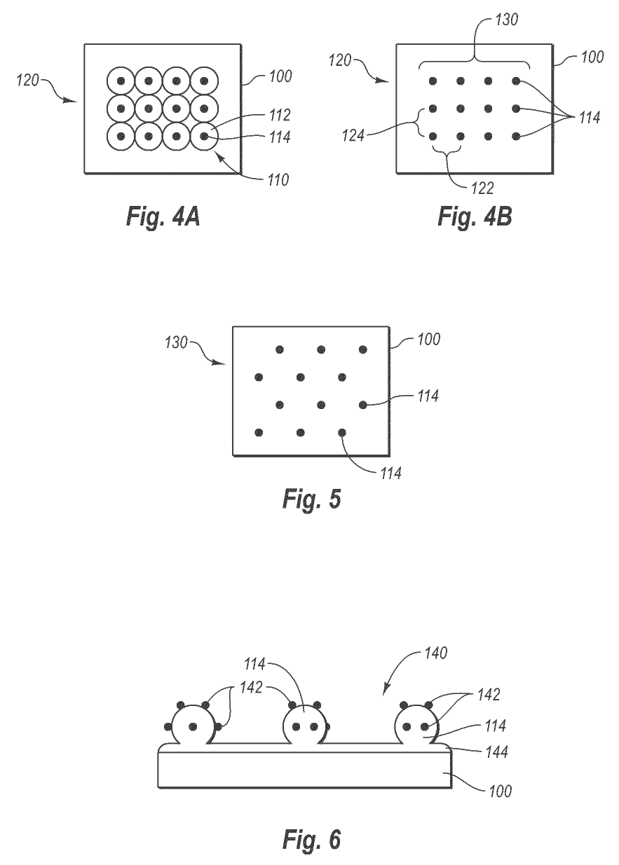

FIGS. 4A and 4B illustrate top views of the self-cleaning surface 120 of FIG. 3. More specifically, FIG. 4A illustrates a top view of the coated nanoparticles 110 that have been applied to the substrate 100. FIG. 4B illustrates the top view of the surface 120 after the shells of the coated nanoparticles 110 have been reduced in volume or removed. FIG. 4B also shows that the shells can provide spacing between the nanoparticles on the substrate.

FIG. 4A illustrates the surface 120 after the coated nanoparticles 110 have been sprayed or otherwise applied to the substrate 100. In this example, the shell 112 spaces the nanoparticles 114 on the substrate 100. Spacing the nanoparticles 114 on the substrate 100 can enhance the hydrophobicity of the self-cleaning surface 120.

The dimensions of the shell 112 provide a spacing between the nanoparticles 114. As a result, the dimensions of the spacing can be controlled by controlling the dimensions and/or volume of the shell 112. The dimensions of the shell 112 can be controlled, for example, by controlling the volume of water in the hydrogel. By controlling the volume or dimensions of the shell 112, as well as the size of the nanoparticles 114 in some embodiments, the hydrophobicity of the self-cleaning surface 120 can be configured.

In one embodiment, a size of the nanoparticles 114 can range from about 200 nanometers to about 2 microns. A thickness of the shell 112 (after absorbing water) can be from about 200 nanometers to about 1 micron. In the surface 120, the sizes of the nanoparticles 114 can be substantially constant for all of the nanoparticles 114 on the surface 120. Alternatively, the sizes of the nanoparticles 114 on the surface 120 can vary.

FIG. 4B illustrates that the nanoparticles 114 remain spaced after the shell 112 has been removed and the nanoparticles 114 are left on the substrate 100. FIG. 4B further illustrates that the nanoparticles 114 are arranged in a pattern 130 on the substrate 100. In this example, dimensions 122 and 124 can be the same of different. In one embodiment, the pattern 130 of the nanoparticles 114 that are deposited on the substrate 100 after the hydrogel shell 112 is removed or shrunk can be determined by the manner in which the shells 112 arrange themselves when applied to the substrate 100. As a result, the pattern 130 may have a symmetrical aspect as well as non-symmetrical aspects. Thus, the pattern 130 can be symmetrical or non-symmetrical or a combination thereof. Further, the pattern 130 may vary as the dimensions of the shells 112 vary.

FIG. 5 illustrates that the nanoparticles 114 can be arranged in different patterns or in an asymmetrical manner on the substrate 100. In other words, the pattern 130 of the nanoparticles 114 can vary and may be arranged geometrically, symmetrically, asymmetrically, randomly, and the like or any combination thereof. For example, the pattern 130 may be square shaped, rectangular, hexagonal, octagonal, triangular, or the like. In addition, the pattern 130 can be controlled or partially controlled as the coated nanoparticles 110 are applied or sprayed or otherwise deposited on the substrate 100. For example, using the coated nanoparticles 110 of different dimensions can result in the pattern 130 being distinct from a situation where the coated nanoparticles 110 have substantially the same dimensions. As previously described, the pattern 130 may be random or partially random. For example, the distance between the nanoparticles 114 may also vary because the dimensions of the various shells may also vary.

After the coated nanoparticles 110 are applied to the substrate 100, the surface 120 or the coated nanoparticles 110 are dried and/or fired. Drying the coated nanoparticles 110 can remove the shell 112 (e.g., cause the onset of water loss) or substantially reduce the volume of the shell 112. Drying the coated nanoparticles 110 or firing the surface 120 can also affix or partially affix the nanoparticles 114 to the substrate 100. Once affixed or attached to the substrate 100, the nanoparticles 114 cannot be easily removed. After drying and/or firing the coated nanoparticles 110, the surface 120 includes spaced nanoparticles 114 that are affixed to the substrate 100.

This aspect of applying the nanoparticles 114 to the substrate 100 can provide the surface 120 with hydrophobicity.

FIG. 6 illustrates one embodiment of a self-cleaning surface where additional nanoparticles have been applied to the self-cleaning surface. After the nanoparticles 114 are affixed to the substrate 100, a mixture may be applied to the nanoparticles 114 attached or otherwise connected to the substrate 100.

The mixture may include nanoparticles 142 that are typically smaller in size than the nanoparticles 114. The nanoparticles 142 in the mixture may be, by way of example only, Titanium Dioxide (TiO₂) nanoparticles. The nanoparticles 142 in the mixture may have photocatalytic properties or antifouling properties. The nanoparticles 142 can be sprayed onto the surface 120, or applied by immersing the surface 120 in the mixture, or in other manners. The mixture may be a colloid mixture in one example.

In one example, a spin-coating of sol-nanoparticle mixture can be used to apply the nanoparticles 142 onto the surface 120. The mixture may have enough viscosity to keep the nanoparticles 142 distributed over the surface 120. With sufficient viscosity, the nanoparticles 142 will remain substantially evenly distributed over the surface 120 and on the nanoparticles 114. In one embodiment, a polymer may be added into the mixture in increase the viscosity of the mixture and enhance a uniform distribution of the nanoparticles 142 on the surface 120 and/or on the nanoparticles 114.

The nanoparticles 142 can attach to the nanoparticles 114 in a random pattern or be spaced in certain embodiments. As indicated previously, the nanoparticles 142 may be distributed substantially uniformly when attached to the nanoparticles 114.

The nanoparticles 142 in the mixture may have a density that determines a density of the nanoparticles 142 on the nanoparticles 114.

A size of the nanoparticles 142 can range from about 5 nanometers to about 200 nanometers. In some embodiments, the nanoparticles 142 are typically smaller in size than the nanoparticles 114.

The nanoparticles 142 can form nanorods or protrusions on the nanoparticles 114. In this example, the nanoparticles 114 form a first layer on the substrate 100 and the nanoparticles 142 form a second layer that is formed on the first layer as described herein.

When the nanoparticles 142 are formed of TiO₂, or of other materials that may enable photocatalytic conversion from water, the nanoparticles 142 may provide hydrophilic properties to a surface 140, which is an example of the surface 120 after the application of the nanoparticles 142. Thus, the first layer of nanoparticles 114 may provide the surface 140 with hydrophobic properties or characteristics and the second layer of nanoparticles 142 may provide the surface 140 with hydrophilic properties.

As a result, the surface 140 can have self-cleaning (e.g., antifouling, water repelling and contaminant repelling) characteristics. Water and other contaminants can be repelled via the hydrophobic aspect and/or decompose contaminants using reactive radicals that are generated from photocatalytic conversion from water mediated by, for example, TiO₂ used to form the nanoparticles 142.

The surface 140, as illustrated in FIG. 6, is then fired a second time to complete the surface 140 having self-cleaning characteristics. Firing the surface 140 can affix the nanoparticles 142 to the nanoparticles 114 in the surface 140, as shown in FIG. 6. More specifically, FIG. 6 illustrates the nanoparticles 142 that are connected or attached to the nanoparticles 114. In some embodiments, the mixture may leave a layer 144 of material, such as TiO₂ on the surface of the substrate 100.

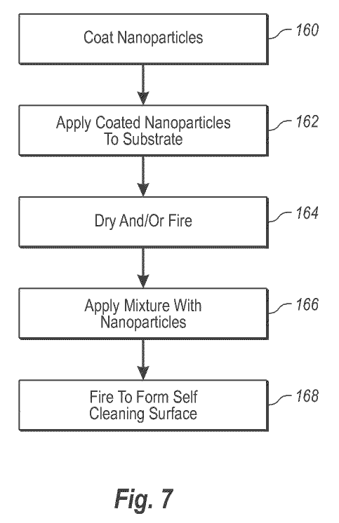

FIG. 7 is a flow diagram of an illustrative embodiment of a method for forming a self-cleaning surface. Beginning in block 160, first nanoparticles such as silicon dioxide nanoparticles are coated in a volume changing material such as a hydrogel. Coating the nanoparticles encases the nanoparticles in a shell of the volume changing material. In block 162, the coated nanoparticles are then applied to a substrate. As the coated nanoparticles are applied to the substrate, the shells cause the nanoparticles to be spaced on the substrate.

The spacing advantageously causes the self-cleaning surface to effectively have microbumps, which can provide the surface with hydrophobicity.

In block 164, the surface is dried and/or fired. Drying the surface can cause the volume changing material to experience a change in volume. In some hydrogels, for example, water is released and the shells shrink in size and or are removed from the surface or from the nanoparticles in some embodiments.

Firing the surface at this stage of the process can permanently affix or attach the nanoparticles to the substrate.

In block 166, after the nanoparticles are attached to the substrate, by firing in one embodiment, a mixture or solution containing different nanoparticles is applied to the surface. The solution or mixture, which contains second nanoparticles, is applied to form a second layer on the self-cleaning surface. The second nanoparticles are typically smaller than the first nanoparticles. The second nanoparticles may attach to the first nanoparticles such that each of the first nanoparticles may have a multiple number of the second nanoparticles disposed thereon. For example, each silicon dioxide nanoparticle may have multiple titanium dioxide particles disposed thereon. The second nanoparticles effectively form small nanorods or other structure elevations on the surface of the first nanoparticles.

In block 168, after the solution or mixture is applied, the surface is fired a second time to finalize the self-cleaning surface. The second nanoparticles, which may be formed of titanium dioxide, may provide hydrophilic properties. As a result, the self-cleaning surface may have both hydrophobic and/or hydrophilic properties to repel water and contaminants as well as decompose contaminants using reactive radicals, such as OH radicals, which are generated from photocatalytic conversion from water mediated by the titanium dioxide nanoparticles. The second nanoparticles can be doped and/or undoped.

The self-cleaning surface thus provides, in one embodiment, a titanium dioxide nanoparticle-laden self-cleaning surface to repel water and/or contaminants.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method for forming a self-cleaning surface, the method comprising:
coating first nanoparticles such that at least a majority of the first nanoparticles are each encased in a shell;
applying the coated first nanoparticles to a substrate, wherein the shells provide spacing between the first nanoparticles applied to the substrate;
removing at least a portion of the shells;
applying a mixture to the spaced first nanoparticles on the surface of the substrate, the mixture including second nanoparticles; and
firing the surface to provide a self-cleaning surface.

2. The method of claim 1, wherein the first nanoparticles comprise SiO₂ and the second nanoparticles comprise TiO₂.

3. The method of claim 1, wherein coating first nanoparticles such that at least a majority of the nanoparticles are each encased in a shell further comprises coating the first nanoparticles with a material that experiences volume changes according at least to temperature.

4. The method of claim 3, wherein the material that experiences volume changes comprises a hydrogel.

5. The method of claim 1, wherein applying the coated first nanoparticles to a substrate further comprises spraying the coated first nanoparticles on the substrate.

6. The method of claim 5, wherein the substrate comprises at least one of glass, ceramic, or metal.

7. The method of claim 1, wherein removing the shells further comprises drying the coated first nanoparticles to remove the shells such that the first nanoparticles are spaced on the substrate according to dimensions of the shells.

8. The method of claim 1, wherein applying a mixture further comprises applying a TiO₂ mixture to the first nanoparticles, wherein the second nanoparticles include TiO₂ nanoparticles and wherein the TiO₂ mixture is one of doped or undoped.

9. The method of claim 8, wherein the TiO₂ nanoparticles adhere to the SiO₂ nanoparticles to form a surface laden with TiO₂ photocatalytic nanoparticles.

10. The method of claim 1, wherein the first nanoparticles provide hydrophobicity to the self-cleaning surface and the second nanoparticles provide hydrophilicity to the self-cleaning surface.

11. A self-cleaning surface comprising:
a substrate;
a first layer formed from a plurality of first nanoparticles disposed on the substrate, wherein the first nanoparticles are spaced on the substrate to form microbumps;
a second layer formed from a plurality of second nanoparticles that are applied to the first layer and that adhere to the first nanoparticles, wherein the second nanoparticles form nanorods on the microbumps.

12. The self-cleaning surface of claim 11, wherein the first nanoparticles comprise SiO₂ particles and the second nanoparticles comprise TiO₂ particles.

13. The self-cleaning surface of claim 11, wherein the substrate comprises at least one of glass, ceramic, or metal.

14. The self-cleaning surface of claim 11, wherein the plurality of first nanoparticles are spaced by encasing the first nanoparticles in polymer shells, wherein the polymer shells are removed before the plurality of second nanoparticles are applied to the plurality of first nanoparticles.

15. The self-cleaning surface of claim 11, wherein the polymer shells comprise hydrogel and wherein the polymer shells are removed by drying.

16. The self-cleaning surface of claim 11, wherein the self-cleaning surface structure is fired to finalize the self-cleaning surface and wherein the first nanoparticles provide the self-cleaning surface with at least hydrophobicity and wherein the second nanoparticles provide hydrophilicity.

17. The self-cleaning surface of claim 11, wherein the self-cleaning surface decomposes contaminants using reactive radicals which are generated from photocatalytic conversion from water mediated by the second nanoparticles.

18. The self-cleaning surface of claim 11, wherein the self-cleaning surface is at least partially hydrophobic and has a contact angle between about 90 degrees and about 175 degrees.

19. A method for forming a self-cleaning surface that is repellant to water and contaminants, the method comprising:
spacing first nanoparticles on a substrate;
firing the first nanoparticles on the surface to fix the first nanoparticles to the substrate;
applying a mixture containing second nanoparticles to the first nanoparticles to form a surface structure; and
firing the surface structure, wherein the surface structure is configured to repel water with at least the first nanoparticles and decompose contaminants with at least the second nanoparticles.

20. The method of claim 19, wherein the surface structure is hydrophobic and has a contact angle between about 90 degrees and about 175 degrees.

21. The method of claim 20, wherein spacing first nanoparticles further comprises:
coating the first nanoparticles with polymer shells;
applying the coated first nanoparticles to the substrate; and
at least partially removing the polymer shells such that the first nanoparticles are spaced according to a size of the polymer shells.
